(19) United States
(12) Patent Application Publication
(10) Pub. No.: US 2007/0016641 A1
(43) Pub. Date: Jan. 18, 2007

(54) Identifying and blocking instant message spam

(75) Inventor: Matthew E. Broomhall, South Burlington, VT (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/179,199

(22) Filed: Jul. 12, 2005

(51) Int. Cl. G06F 15/16

(52) U.S. Cl. 709/206

(57) ABSTRACT

Embodiments of the present invention address deficiencies of the art in respect to instant messaging and spim management and provide a novel and non-obvious method, system and computer program product for blocking spim in an instant messaging system. In one embodiment, a data processing system for blocking spim can include instant messaging server logic, a pre-filter database comprising words and/or phrases associated with spim, and a spim sentry coupled to the pre-filter database and the instant messaging server logic. The spim sentry can include program code enabled to block instant messages as spim which contain a threshold number of words and/or phrases which match the words in the pre-filter database.

### BACKGROUND OF THE INVENTION

1. Field of the Invention

The present invention relates to the field of instant messaging and more particularly to the field of unsolicited commercial instant messages.

2. Description of the Related Art

Historically, the print medium served as the principal mode of unsolicited mass advertising on the part of the direct marketing industry. Typically referred to as “junk mail”, unsolicited print marketing materials could be delivered in bulk to a vast selection of recipients, regardless of whether the recipients requested the marketing materials. With an average response rate of one to two percent, junk mail has been an effective tool in the generation of new sales leads. Nevertheless, recipients of junk mail generally find the practice to be annoying. Additionally, postage for sending junk mail can be expensive for significant “mail drops”. Consequently, the direct marketing industry constantly seeks equally effective, but less expensive modalities for delivering unsolicited marketing materials.

The advent of electronic mail has provided much needed relief for direct marketers as the delivery of electronic mail to a vast number of targeted recipients requires no postage. Moreover, the delivery of unsolicited electronic mail can be an instantaneous exercise and the unsolicited electronic mail can include embedded hyperlinks to product or service information thus facilitating an enhanced response rate for the “mail drop”. Still, as is the case in the realm of print media, unsolicited electronic mail, referred to commonly as “spam”, remains an annoyance to consumers worldwide. As a result, an entire cottage industry of “spam filters” has arisen whose task solely is the eradication of spam.

Like electronic mail, instant messaging has proven to be fertile ground for the mass marketer. Referred to in the art as “spim”, unsolicited instant messages have proven to be even a greater annoyance than spam. When received in an e-mail server, spam is not noticed by the recipient until the inbox for the e-mail server has been scanned. At worst, a “new message” notification can be activated pending the review of the newly received spam message by the recipient. In the case of instant messaging, however, the impact is immediate.

Specifically, spim when received causes the activation of a viewer which can “pop up” and distract the recipient. Moreover, spim like spam can consume network resources which can drain user productivity. Even workplace issues can arise where spim includes sexually explicit materials which can be viewed by unsuspecting passersby in proximity to the instant messenger client. Importantly, unlike e-mail based spam, instant messaging based spim cannot be merely deleted. Rather, the spim can become part of the record of the instant messaging session.

Spim often can be generated by “bots”—automated logic charged with the task of identifying possible instant messenger recipients and forwarding instant messages to the recipients as if the instant messages originated from an actual instant message user. Often, the list of instant messenger recipients can be generated randomly, or harvested through Internet probing operations. Given the level of automation available to the spim artist, estimates now place spim at epidemic levels in excess of 500 million spims per day.

Several products have attempted to address the spim epidemic. For example, anti-spim filters have been developed to identify keywords in spim in order to quash the receipt of spim messages. Additionally, it is known to block the receipt of an incoming instant message from a particular instant messenger identifier or screen name. Some systems restrict the receipt of instant messages to those which originate from within a specified domain or network. Yet other systems identify instant messenger sources which have added the recipient to a buddy list. Consequently, a “reverse buddy list” can be generated based upon which subsequent messages can be blocked which originate from users in the reverse buddy list. In all cases, however, spim remains a troublesome element of computer communications.

### BRIEF SUMMARY OF THE INVENTION

Embodiments of the present invention address deficiencies of the art in respect to instant messaging and spim management and provide a novel and non-obvious method, system and computer program product for blocking spim in an instant messaging system. In one embodiment, a data processing system for blocking spim can include instant messaging server logic, a pre-filter database comprising words and/or phrases associated with spim, and a spim sentry coupled to the pre-filter database and the instant messaging server logic. The spim sentry can include program code enabled to block instant messages as spim which contain a threshold number of words and/or phrases which match the words in the pre-filter database.

The data processing system also can include a block list of instant message sources associated with spim coupled to the spim sentry. Likewise, the data processing system yet further can include a database of blocked instant messages coupled to the spim sentry. The database of blocked instant messages can include source data for instant messages blocked by the spim sentry. In this regard, the source data can include at least one of a source identifier (ID), an Internet protocol (IP) address, a domain name and a media access control (MAC) address.

Another embodiment can include a method for blocking spim. The method can include receiving an instant message, parsing the instant message for words in the instant message, comparing the words with words in a pre-filter database, and blocking the instant message if a threshold number of compared words in the instant message are present in the pre-filter database. The method also can include identifying a source of the instant message, looking up the source in a blocked list, and blocking the instant message if the source is in the blocked list. Finally, the blocking step can include writing source data for the source to a database of blocked instant messages, determining whether a threshold number of instant messages associated with the source have been blocked, and adding the source to the blocked list if a threshold number of instant messages associated with the source have been blocked.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an instant messaging system configured to block spim; and,

FIG. 2 is a flow chart illustrating a process for blocking spim in an instant messaging system.

### DETAILED DESCRIPTION OF THE INVENTION

Embodiments of the present invention provide a method, system and computer program product for blocking spim in an instant messaging system. In accordance with an embodiment of the present invention, a database of pre-filtered words and phrases can be maintained in which pre-filtered words and phrases can be indicative of spim. Incoming instant messages can be parsed to determine whether the instant messages include words and phrases matching words and phrases in the database of pre-filtered words and phrases. Where a match is detected, the instant message can be blocked as spim. Moreover, to the extent that a threshold number of spim originates from a particular source, the source can be blocked from sending instant messages in the instant messaging system.

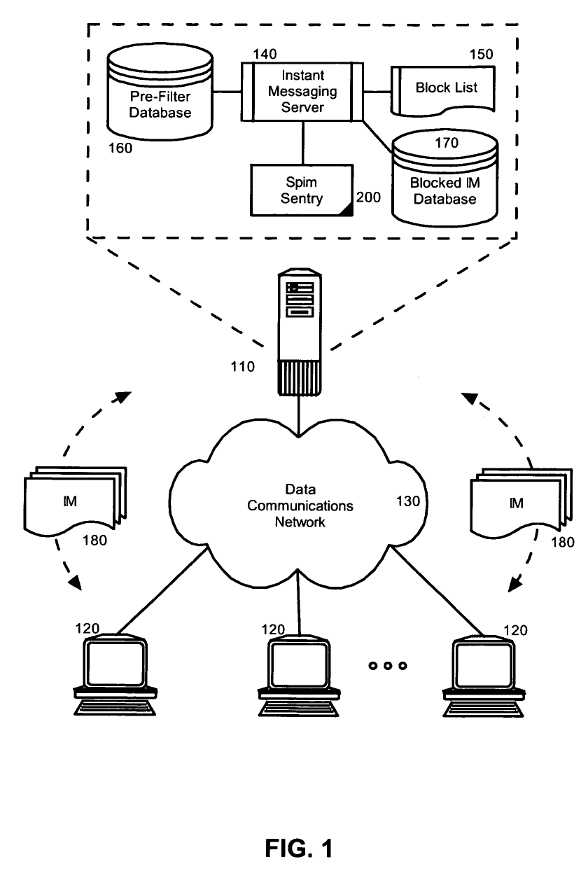

In more particular illustration, FIG. 1 is a schematic illustration of an instant messaging system configured to block spim. As shown in FIG. 1, the instant messaging system can include an instant messaging server 110 communicatively coupled to one or more instant messaging clients 120 over a data communications network 130. The instant messaging server 110 can include instant messaging server logic 140 programmed to moderate the exchange of instant messages 180 between the instant messaging clients 120 over the data communications network 130.

Notably, a database of pre-filtered words and phrases 160 can be coupled to the instant messaging server logic 140. The database of pre-filtered words and phrases 160 can include a listing of words and phrases which have been associated with spim such that the presence of one or more of the words and phrases in an instant message can reveal the instant message as spim. A database of blocked instant messages 170 further can be coupled to the instant messaging server logic 140. The database of blocked instant messages 170 can include records for blocked instant messages. The records can include, by way of example, the identity of the sender and when the message had been sent. Finally, a list of blocked sources of instant messages 150 yet further can be coupled to the instant messaging server logic 140. The list of blocked sources of instant messages 150 can include a listing of message sources that are not permitted to propagate instant messages in the instant messaging system.

Notably, a spim sentry 200 can be coupled to the instant messaging server 140. The spim sentry 200 can include program code enabled to parse incoming instant messages 180 to determine whether words and phrases in the instant messages 180 match or correlate to words and phrases in the database of pre-filtered words and phrases 160. Where a match or correlation is determined, the spim sentry 200 can block the instant message as spim and a record can be written to the blocked instant message database 170. When a threshold number of instant messages have been blocked for a particular message source, the message source can be added to the list of blocked sources of instant messages 150. In this regard, the spim sentry 200 can block all attempts by a source included in the list of blocked sources of instant messages 150 to transmit an instant message in the instant messaging system.

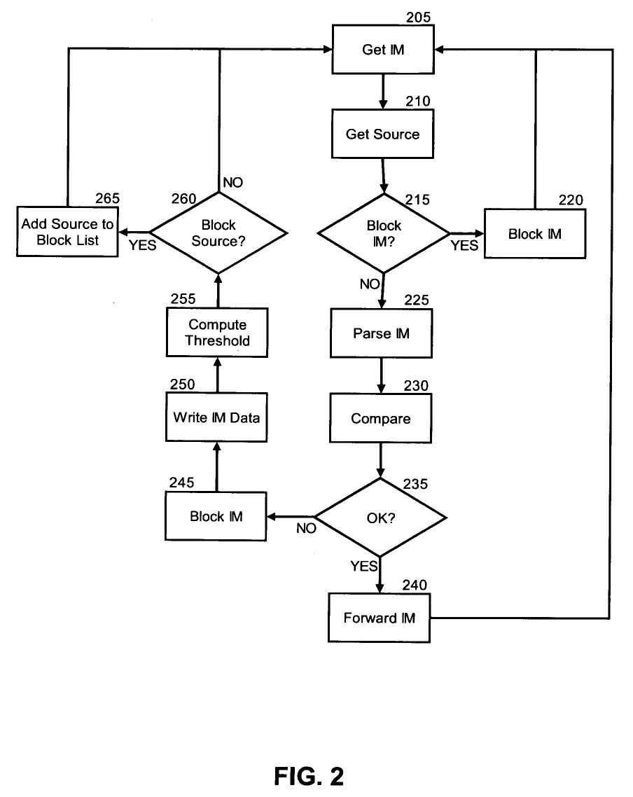

In further illustration of the operation of the spim sentry 200, FIG. 2 is a flow chart illustrating a process for blocking spim in an instant messaging system. Beginning in block 205, an instant message can be received for processing in the instant messaging system. In block 210, the source of the instant message can be identified and in decision block 215 it can be determined whether to block the instant message based upon the identity of the source of the instant message. If so, the message can be blocked in block 220. Otherwise, the process can continue through block 225.

In block 225, the content of the instant message can be parsed to process individual words and phrases in the instant message. Thereafter, in block 230 the individual words and phrases of the instant message can be compared to words and phrases which have been pre-defined to be associated with spim. In decision block 235, if a threshold number of words and phrases in the instant message do not match the pre-defined words and phrases, in block 240 the instant message can be forwarded to its intended destination. Otherwise, the process can continue through block 245.

In block 245, the instant message can be blocked. Also, in block 250 data regarding the blocked message can be recorded. The data can include the user ID of the source, the IP address of the source, the domain name of the source, and the MAC address of the source. In block 255, it can be computed whether messages from the source had been previously blocked and whether a threshold number of messages had been blocked within a fixed period of time previously. In decision block 260, based upon the computation it can be determined whether to block all instant messages from the source. If so, in block 265, the identity of the source can be added to a list of blocked sources for subsequent use in decision block 215.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A data processing system for blocking spim comprising:
instant messaging server logic;
a pre-filter database comprising words associated with spim; and,
a spim sentry coupled to said pre-filter database and said instant messaging server logic, said spim sentry comprising program code enabled to block instant messages as spim which contain a threshold number of words matching said words in said pre-filter database.

2. The data processing system of claim 1, wherein said pre-filter database further comprises phrases associated with spim.

3. The data processing system of claim 1, further comprising a block list of instant message sources associated with spim coupled to said spim sentry.

4. The data processing system of claim 1, further comprising a database of blocked instant messages coupled to said spim sentry, said database of blocked instant messages comprising source data for instant messages blocked by said spim sentry.

5. The data processing system of claim 4, wherein said source data comprises at least one of a source identifier (ID), an Internet protocol (IP) address, a domain name and a media access control (MAC) address.

6. A method for blocking spim comprising:
receiving an instant message;
parsing said instant message for words in said instant message;
comparing said words with words in a pre-filter database; and,
blocking said instant message if a threshold number of compared words in said instant message are present in said pre-filter database.

7. The method of claim 6, further comprising:
identifying a source of said instant message;
looking up said source in a blocked list; and,
blocking said instant message if said source is in said blocked list.

8. The method of claim 6, wherein said parsing said instant message for words in said instant message comprises parsing said instant message for words and phrases in said instant message, and wherein said comparing said words with words in a pre-filter database comprises comparing said words and phrases with words and phrases in a pre-filter database, and wherein said blocking said instant message if a threshold number of compared words in said instant message are present in said pre-filter database comprises blocking said instant message if a threshold number of compared words and phrases in said instant message are present in said pre-filter database.

9. The method of claim 7, wherein said blocking said instant message if a threshold number of compared words in said instant message are present in said pre-filter database further comprises:
writing source data for said source to a database of blocked instant messages;
determining whether a threshold number of instant messages associated with said source have been blocked; and,
adding said source to said blocked list if a threshold number of instant messages associated with said source have been blocked.

10. A computer program product comprising a computer usable medium having computer usable program code for blocking spim, said computer program product including:
computer usable program code for receiving an instant message;
computer usable program code for parsing said instant message for words in said instant message;
computer usable program code for comparing said words with words in a pre-filter database; and,
computer usable program code for blocking said instant message if a threshold number of compared words in said instant message are present in said pre-filter database.

11. The computer program product of claim 10, further comprising:
computer usable program code for identifying a source of said instant message;
computer usable program code for looking up said source in a blocked list; and,
computer usable program code for blocking said instant message if said source is in said blocked list.

12. The computer program product of claim 10, wherein said computer usable program code for parsing said instant message for words in said instant message comprises computer usable program code for parsing said instant message for words and phrases in said instant message, and wherein said computer usable program code for comparing said words with words in a pre-filter database comprises computer usable program code for comparing said words and phrases with words and phrases in a pre-filter database, and wherein said computer usable program code for blocking said instant message if a threshold number of compared words in said instant message are present in said pre-filter database comprises computer usable program code for blocking said instant message if a threshold number of compared words and phrases in said instant message are present in said pre-filter database.

13. The computer program product of claim 11, wherein said computer usable program code for blocking said instant message if a threshold number of compared words in said instant message are present in said pre-filter database further comprises:
computer usable program code for writing source data for said source to a database of blocked instant messages;
computer usable program code for determining whether a threshold number of instant messages associated with said source have been blocked; and,
computer usable program code for adding said source to said blocked list if a threshold number of instant messages associated with said source have been blocked.
